(19) United States
(12) Patent Application Publication
(10) Pub. No.: US 2023/0245016 A1
(43) Pub. Date: Aug. 3, 2023

(54) STAFF REQUIREMENT GENERATION METHOD AND SYSTEM ACCOUNTING FOR MULTI-SKILL AND MULTI-SESSION EFFICIENCY

(71) Applicant: NICE LTD, Ra'anana (IL)

(72) Inventors: Xiaoqing SUN, Flower Mound, TX (US); William Nathan STEARNS, Richardson, TX (US)

(21) Appl. No.: 17/589,023

(22) Filed: Jan. 31, 2022

(51) Int. Cl. G06Q 10/06

(52) U.S. Cl. CPC G06Q 10/063118; G06Q 10/063112

(57) ABSTRACT

A fast, robust and efficient staff requirement calculation engine that estimates staffing requirements on the spot to account for multi-skill omni-channel efficiency. The calculation engine may be used off-line for pre-calculating staff requirements in a multi-skill environment for different queues at different intervals and on-line for instantaneous responses to demands for staff requirement calculation.

### TECHNICAL FIELD

The present disclosure relates generally to methods and systems of determining staff requirements to service contacts arriving in omni channels, which include traditional voice channels as well as digital channels, and more specifically relates to methods and systems of determining staff requirements while accounting for multi-skill and multi-session efficiency.

### BACKGROUND

Methods for forecasting, planning, and analysis for contact processing centers, also known as call centers, are important for increasing the efficiency of contact processing centers. Workforce management (WFM) is an integrated set of processes that a company uses to optimize the productivity of its employees. For example, WFM includes applications that enable contact center management to forecast workloads and align staffing needs around those forecasts. WFM involves effectively forecasting labor requirements and creating and managing staff schedules to accomplish a particular task on a day-to-day and hour-to-hour basis. WFM planning products typically tell a company how much staff they need, i.e., full time equivalent (FTE)/agents.

Staff requirement estimation is one important part in WFM or WFM scheduling. Customers communicate with businesses through traditional media like phone calls and digital media like chats, emails, short message service (SMS), and social media. Agents at a contact center are trained to have multiple skills and serve customers through different media and different needs such as customer service or technical support. Having multiple skills helps with managing peaks and valleys of different queues, and multi-skill efficiency gains can be achieved through increased agent occupancy.

Because some channels can be served simultaneously, efficiency can also be gained through multi-sessions. Interactions in different queues can have different service objectives, different arrival patterns, and different handling or processing times. Because of these variables, the calculation of accurate staff requirement values is difficult.

All WFM systems have some form of calculation to estimate staffing requirements. Current methods rely on a basic workload formula or the Erlang C (or a derivative) formula with or without subsequent adjustments to the Erlang C output. The adjustment can be derived through simulation, historical averages, or user provided inputs. Existing solutions, however, rely on broad assumptions that do not reflect real-world work processing practices, historical results that are not necessarily repeatable for future intervals, or complex simulations that demand significant time and processing capabilities, or combinations thereof.

Accordingly, a need exists for improved systems and methods for efficiently determining staffing requirements while accounting for multi-skill and multi-session efficiency.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a simplified block diagram of a computer system flow according to various aspects of the present disclosure.

FIGS. 2A and 2B illustrate a flowchart of a method according to embodiments of the present disclosure.

FIG. 3 is an exemplary output of single-skill multi-session staff requirement estimates according to embodiments of the present disclosure.

FIG. 4 illustrates an exemplary mapping of contact types to skill groups according to embodiments of the present disclosure.

FIG. 5 illustrates an exemplary graph that is used to solve for normalized volume according to embodiments of the present disclosure.

FIG. 6 is a block diagram of a computer system suitable for implementing one or more components in FIG. 1 according to one embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein estimate staff requirements in a contact center, back office, a branch office, a retail office, field services, or similar settings. The well-known difficulty in staff requirement estimation arises from multi-skill and multi-session efficiency gains when employees or agents possess multiple skills and service multiple contact types or interactions simultaneously within and across channels. The present methods strike a balance between complex simulation and inaccurate Erlang C algorithms used in traditional staff requirement estimation. In particular, the present methods utilize single-skill multi-session simulation, queue type-specific service objectives, work item processing times, and volume normalization to estimate staff requirements while also accounting for multi-skill and multi-session efficiency.

Advantageously, the present systems and methods estimate staffing requirements quickly to account for multi-skill omni-channel (MSOC) efficiency through use of a calculator that accounts for non-homogeneous service objectives of queues that share MSOC agents directly or indirectly and that accurately estimates pooling effects of shared MSOC agent groups that are different distances away from the serviced queue. The present systems and methods also may advantageously replace the need for full simulation every time an input variable is changed. The calculator uses a single skill simulator to cache single skill FTE values in an off-line array for sub-second processing of FTE requirement calculations. In an exemplary embodiment, the calculator is used off-line for pre-calculating FTE requirements in a multi-skill environment for different queues at different intervals and on-line for instantaneous responses to user demand for FTE requirement calculation. Staff requirement calculation is a function of both online and offline computing, thereby producing accurate results within milliseconds according to the present disclosure.

Furthermore, the present methods and systems overcomes constraints of Erlang C algorithms (and its derivatives). These constraints include assumptions that contacts never abandon, agents are homogeneously skilled, agents are not shared, and agents can only handle one contact at a time, none of which are fully accurate. The present systems and methods account for both single session and multiple session handling, as well as single-skill and multiple-skill handling, within a single algorithm. Finally, the present systems and methods accounts for both an immediate response and deferred response to contacts within a single algorithm. The methods are derived from the field of operations research through application of advanced interpolation techniques designed to search a solution space to find an optimal solution to a given set of constraints.

The MSOC requirement generation generally involves a two-step process. The first step is to generate a single-skill multi-session staff requirement. A queue (also referred to herein as a contact type) such as a “customer service call” can be described with three attributes: (1) a volume in a given time interval (also referred to herein as a contact volume), (2) a processing or handling time, and (3) a service objective. Both volume and processing time are random with a probability distribution. The distribution can be a closed form that is empirical or can be provided by a formula. The service objective can be different for different contact types. For example, the contact type “customer service calls” can have the service objective be “answer 80% of calls within 30 seconds,” the contact type “sales chat” can have the service objective be “have 70% of chats answered within 120 seconds and average response wait time per message of 20 seconds.”

For a given level of volume and a given level of processing time, points estimation for staff requirements can be performed using either an Erlang algorithm or a single skill simulation. To be able to use a conventional Erlang algorithm, contact arrivals should follow a Poisson distribution, and the distribution of processing time is exponential. Single skill simulation can be used for almost all scenarios, however, including multi-session chats with any arrival distribution and any processing time distribution. It can also accommodate different service metrics. Staff requirements are calculated or simulated at different volumes, different processing times, and different service objectives. The single-skill requirement values are then stored or cached for subsequent calculations of MSOC requirements. Cached single-skill staff requirements are used for offline MSOC staff requirement calculations and/or on-line MSOC staff requirement calculations responding to user input.

The second step in generating an MSOC requirement typically involves arrival, processing, and service level normalization, and algebraic operations to obtain staff requirements while accounting for multi-skill efficiency. For example, this step may include mapping contact types to agent skill groups, defining relationships between the contact types, and determining a capacity for agents serving a selected contact type to also serve other contact types.

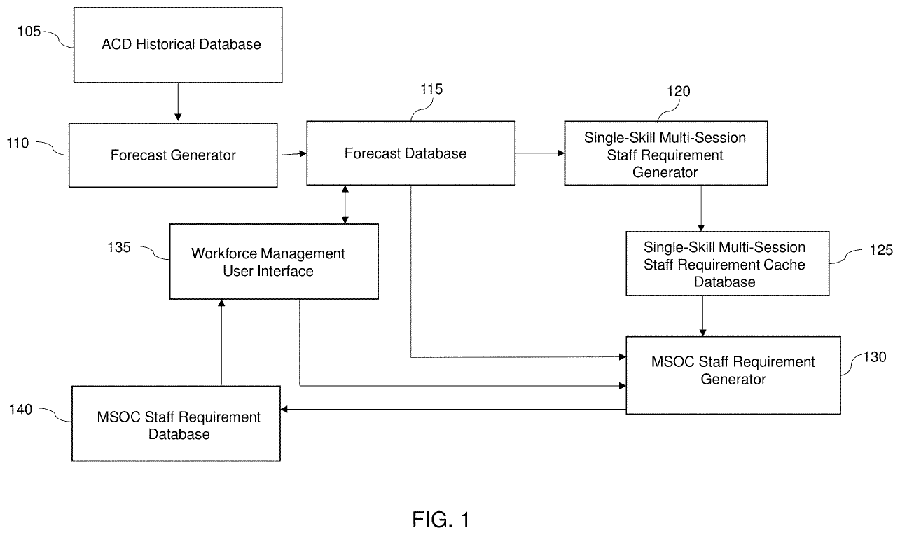

FIG. 1 illustrates a block diagram of an exemplary MSOC computer system flow. The computer system 100 includes automatic communication distributor (ACD) historical database 105, forecast generator 110, forecast database 115, single-skill multi-session staff requirement generator 120, single-skill multi-session staff requirement cache database 125, MSOC staff requirement generator 130, WFM user interface 135, and MSOC staff requirement database 140. The historical data from ACD historical database 105 is used by forecast generator 110 to produce forecasted contact volumes and processing times. The results are stored in forecast database 115. Based on the forecasted data, single-skill multi-session staff requirement generator 120 provides staff requirement estimates for a range of contact volumes and processing times. The results are stored in single-skill multi-session staff requirement cache database 125. MSOC staff requirement generator 130 generates staff requirements for different contact types while accounting for multi-skill and multi-session efficiency. The results are stored in MSOC staff requirement database 140. Both stored forecasted results 115 and stored MSOC staff requirements 140 can be viewed by a user through the WFM user interface 135. The results can also be fed to other systems such as a schedule generator. Advantageously, a user can adjust forecasted results and receive new MSOC staff requirements instantaneously. MSOC staff requirement generator 130 provides a fast response to the adjustments made by the user.

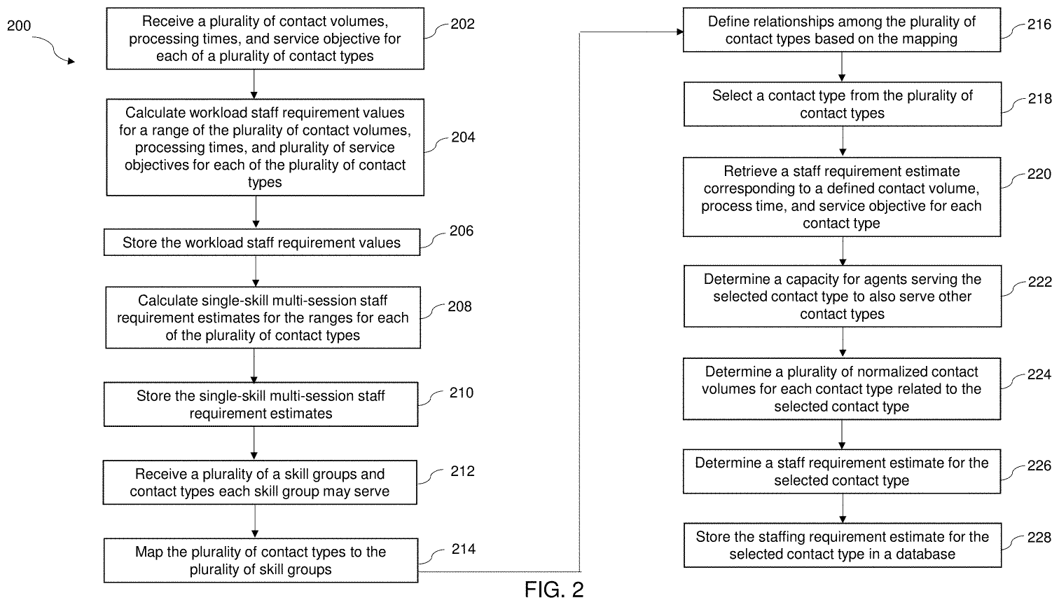

Referring now to FIG. 2A, a method 200 according to embodiments of the present disclosure is described. At step 202, single-skill multi-session staff requirement generator 120 receives a plurality of contact volumes, a plurality of processing times, and a plurality of service objectives for each of a plurality of contact types. In one or more embodiments, the contact types include phone, live chat, messaging chat, short message service (SMS), email, social media, or any combination thereof. In an exemplary embodiment, single-skill multi-session staff requirement generator 120 receives the information from forecast database 115.

At step 204, single-skill/multi-session staff requirement generator 120 calculates workload staff requirement values for a range of the plurality of contact volumes, a range of the plurality of processing times, and a range of the plurality of service objectives for each of the plurality of contact types. In one or more embodiments, workload staff requirement values are calculated according to the following equation:

wᵢ=E(vᵢ*pᵢ)

where wᵢ is workload FTE, vᵢ is the number of contact arrivals in a unit of time, pᵢ is the processing time for an interaction, and E stands for expected or mean. This workload FTE, however, does not represent typical work patterns. In an incoming call center, the work does not typically arrive in a back-to-back fashion. Instead, the work arrives whenever customers decide to contact the call center. The workload is random rather than sequential.

At step 206, single-skill multi-session staff requirement generator 120 stores the workload staff requirement values in, for example, single-skill multi-session staff requirement cache database 125. The values can be retrieved by MSOC staff requirement generator 130 for further calculations.

At step 208, single-skill multi-session staff requirement generator 120 receives a number of simultaneous sessions allowed for each of the plurality of contact types from forecast database 115. The number may be a mean, mode, minimum, and/or maximum number of simultaneous sessions.

At step 210, single-skill multi-session staff requirement generator 120 calculates the single-skill multi-session staff requirement estimates for the range of the plurality of contact volumes, the range of the plurality of processing times, and the range of the plurality of service objectives for each of the plurality of contact types based on the number of simultaneous sessions allowed. The single-skill multi-session staff requirement estimate is the staff requirement assuming agents only have a single skill (and are not multi-skilled), and necessitates a limit on the number of multi-sessions an agent is allowed to handle. The number of simultaneous sessions is not limitless. In one or more embodiments, single-skill multi-session staff requirement generator 120 uses an Erlang algorithm (e.g., an Erlang A, Erlang B, or Erlang C) or a single-skill multi-session simulation to calculate the single-skill multi-session staff requirement estimates, although any suitable form of estimation may be used. In one or more embodiments, the single-skill multi-session requirement estimate can be represented as fⱼ(vⱼ, pⱼ, sⱼ) where fⱼ is either from Erlang C or simulation estimation, and vⱼ is contact volume, pⱼ is processing time, and sⱼ is service objective.

In one or more embodiments, single-skill multi-session staff requirement generator 120 uses a single-skill multi-session simulation to calculate the single-skill multi-session staff requirement estimates. The purpose of a contact center simulator is to mimic call routing given the routing rules of the ACD while attempting to adjust work schedules to fit call volume and category requirements. A simulator models the ACD and simulates how long contacts wait to be served by agents, which contacts are routed to which agents, and the durations of agent-contact interactions. The use of simulators is well-known, and one of ordinary skill in the art, with the benefit of this disclosure, would understand how to use a simulator to calculate such single-skill multi-session staff requirement estimates. Advantageously, the present methods use simulation to account for real world routing constructs, yet they do not require simulation to be executed each time a user adjusts an input. This provides a real-time response to a call for recalculation when an input variable (e.g., contact volume, processing time, or service objective) is changed.

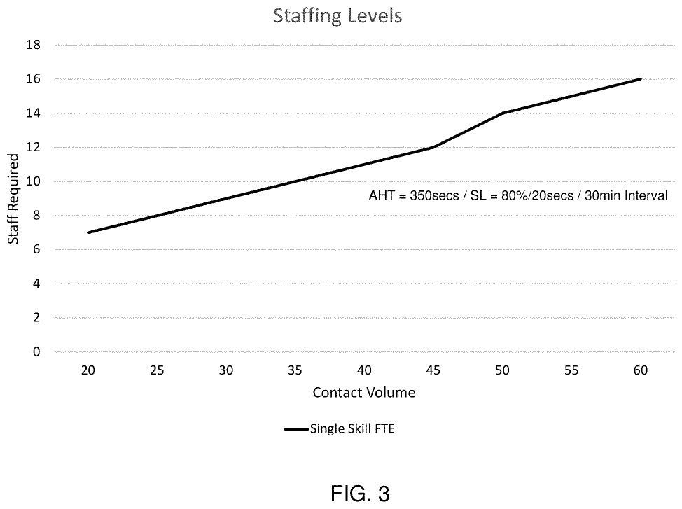

At step 212, single-skill multi-session staff requirement generator 120 stores the single-skill multi-session staff requirement estimates in, for example, single-skill multi-session staff requirement cache database 125. The estimates can be retrieved by the MSOC staff requirement generator as needed for further calculations. FIG. 3 is a sample output that shows the single-skill multi-session staff requirement estimates on a graph where average handling time is given as 350 seconds and the service level objective is to answer 80% of contacts in 20 seconds for 30-minute intervals.

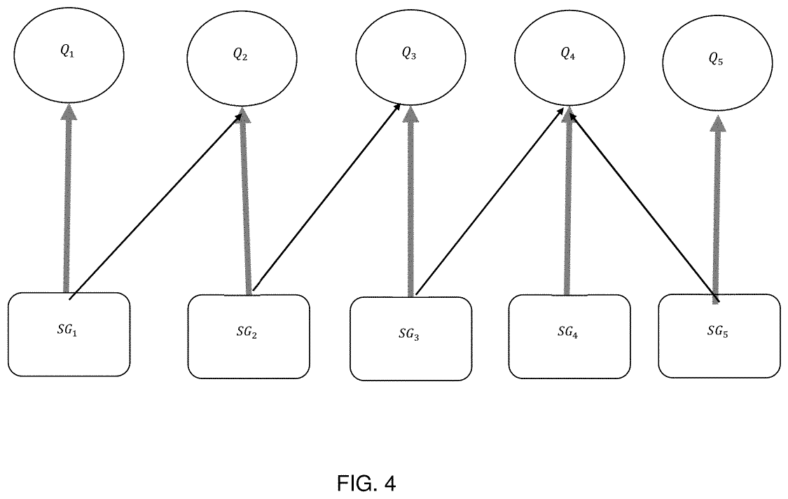

At step 214, MSOC staff requirement generator 130 receives a plurality of skill groups and a plurality of contact types each skill group may serve from WFM user interface 135. Referring to FIG. 4, illustrated are a plurality of contact types Q₁ to Q₅ that are representative contact types that are queued to agents and a plurality of skill groups SG₁ to SG₅ that are representative skill groups of MSOC agents. A skill group is defined as a set of agents with the same ability to serve a set of contact types or queues.

At step 216, MSOC staff requirement generator 130 maps the plurality of contact types to the plurality of skill groups. As seen in FIG. 4, for example, SG₁ can serve both Q₁ and Q₂, and SG₃ can serve both Q₃ and Q₄.

Referring now to FIG. 2B, at step 218, MSOC staff requirement generator 130 defines relationships among the plurality of contact types based on the mapping of the plurality of contact types. As seen in FIG. 4, every contact type is associated with every skill group, either directly or indirectly. For instance, Q₃ directly shares agents from SG₃ with Q₄. Therefore, Q₃ has a zero (0) distance to Q₄. Q₂ does not directly share agents with Q₄. However, Q₂ has a pooling effect with Q₄ through shared agents with Q₃. Therefore, Q₂ has a distance of 1 to Q₄. In this exemplary embodiment, Q₅ is a special queue. Q₅ handles highly deferrable interactions (such as email). Service of deferrable interactions can be deferred to a later time and help with smoothing peaks and valleys in demands. Q₅ directly shares agents with Q₄ and has a distance of zero (0) to Q₄.

At step 220, MSOC staff requirement generator 130 selects a contact type from the plurality of contact types, for example Q₄.

At step 222, MSOC staff requirement generator 130 retrieves, from the stored workload staff requirement values and the stored single-skill multi-session staff requirement estimates in single-skill multi-session staff requirement cache database 125, a staff requirement estimate corresponding to a defined contact volume, a defined processing time, and a defined service objective for each contact type. In other words, a contact volume, a processing time, and a service objective are first selected or defined. Once these variables are defined, MSOC staff requirement generator 130 retrieves a workload staff requirement value for this defined contact volume, defined processing time, and defined service objective from the single-skill multi-session staff requirement cache database 125. Similarly, MSOC staff requirement generator 130 retrieves a single-skill multi-session staff requirement estimate for this defined contact volume, defined processing time, and defined service objective from the single-skill multi-session staff requirement cache database 125.

At step 224, MSOC staff requirement generator 130 determines a capacity for agents serving the selected contact type to also serve other contact types from the plurality of contact types. For example, referring to FIG. 4, if the selected contact type is Q₄, the capacity of SG₁, SG₂, SG₃, SG₄, and SG₅ to serve Q₁, Q₂, Q₃, and Q₅ is also determined. In one or more embodiments, fⱼ(vⱼ, pⱼ, sⱼ)-wⱼ represents the capacity of agents working on Qⱼ to help other contact types. The capacity or the potential to help other contact types is the difference between the single-skill multi-session staff requirement estimate and the workload staff requirement value.

At step 226, MSOC staff requirement generator 130 determines a plurality of normalized contact volumes for each contact type that is related to the selected contact type using the capacity for agents serving the selected contact type determined in step 222, by normalizing each contact volume to the selected contact type based on the defined processing time and the defined service objective of the selected contact type. For each contact type Qⱼ that is not Q₄, the normalized volume may be calculated from the following equation:

vⱼ⁴=argᵥ_{ⱼ}_{⁴}{f₄(vⱼ⁴,p₄,s₄)−vⱼ⁴p₄=fⱼ(vⱼ,pⱼ,sⱼ)−E(vⱼpⱼ)}

to produce Q₄-normalized contact volume based on Q₄'s processing time and service objective.

To solve for Q₄-normalized volume the equation below must be solved:

f₄(vⱼ⁴,p₄,s₄)−E(vⱼ⁴p₄)=c

where c is the difference between the single skill multi-session staff requirement and the workload staff requirement value, which was determined in step 222.

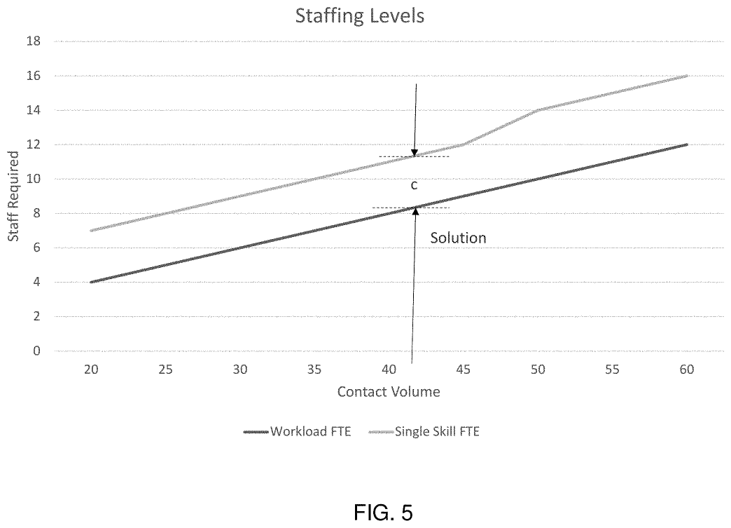

In one or more embodiments, determining the plurality of normalized contact volumes includes using an Erlang algorithm or a single-skill multi-session simulation, or any other suitable form of estimation. Referring now to FIG. 5, the single FTE and the workload FTE is monotonically increasing vs. contact volume. To solve the equation above is to find the staff that has the difference that is “c.” In the case of Erlang C, one can use a bisection search with the Erlang C formula to find that volume that has the difference that is “c.” In the case of single-skill simulation, one can simulate at different levels of contact volume and cache the results. One can also use bisection search to find the two closest cached data points, one cached data point with a volume the difference higher than c, and the other cached data point with the difference that is lower than c. Then one can use interpolation to find the right volume.

In this specific example, Q₅ is a special contact type that is highly deferrable and interruptible (such as email). Therefore, in this case, the staffing requirement is the workload requirement. Agents working on Q₅ can be assigned to other permissible contact types to smooth out demand peaks. In this case, MSOC efficiency gain is more direct. Therefore Q₄-normalized volume for Q₅ is calculated as

v₅⁴=argᵥ_{₅}_{⁴}{f₄(v₅⁴,p₄,s₄)−E(v₅⁴p₄)=d₅w₅}

argᵥ_{₅}_{⁴}{f₄(v₅⁴, p₄, s₄)−E(v₅⁴p₄)=d₅w₅} is the solution when solving for v₅⁴ to satisfy the

f₄(v₅⁴,p₄,s₄)−E(v₅⁴p₄)=d₅w₅ equality:

where d₅∈[0,1] is a calibrated parameter, and w₅ is the workload for Q₅.

At step 228, MSOC staff requirement generator 130 determines a staff requirement estimate for the selected contact type based on the defined contact volume of the selected contact type, the normalized contact volume of each contact type that is related to the selected contact type, and the mapping of the plurality of contact types to the plurality of skill groups In one or more embodiments, the MSOC staff requirement r₄ for Q₄ is calculated as:

r₄=v₄f₄(v₄+β₀[v₅⁴+v₃⁴]+β₁v₂⁴+β₂v₁⁴,p₄,s₄)/(v₄+β₀[v₅⁴+v₃⁴]+β₁v₂⁴+β₂v₁⁴)

where β₀, β₁, β₂∈[0,1] are parameters that can be tuned using MSOC simulation.

In the formula above, v₅⁴, v₃⁴, v₂⁴, and v₁⁴ represent the normalized contact volume of each contact type that is related to the selected contact type Q4, which was determined in step 224 above. Additionally, v₄ represents the defined contact volume of the selected contact type Q₄. The mapping of the plurality of the contact types to the plurality of skill groups is represented in β₀, β₁, and β₂, where the subscript of the βs are the distances to Q4.

In one or more embodiments, the MSOC staff requirement r₄ for Q₄ is calculated as: r₄=v₄*(single-skill multi-session staff requirement estimate for Q₄ that corresponds to the combined volume v₄, v₅⁴, v₃⁴, v₂⁴, and v₁⁴)/(combined volume v₄, v₅⁴, v₃⁴, v₂⁴, and v₁⁴)

In one or more embodiments, MSOC staff requirement generator 130 receives a change to the one or more of the input variables used to calculate the workload staff requirement values or the single-skill multi-session staff requirement estimates. For example, MSOC staff requirement generator 130 may receive a change to one of the plurality of contact volumes, one of the plurality of processing times, or one of the plurality of service objectives.

Advantageously, MSOC staff requirement generator 130 generates an updated staff requirement estimate for the selected contact type quickly. In some embodiments, a user is able to view the plurality of contact volumes, the plurality of processing times, the plurality of service objectives, and the staff requirement estimate for the selected contact type on the WFM interface 135.

At step 230, MSOC staff requirement generator 130 stores the staffing requirement estimate for the selected contact type in a database, e.g., MSOC staff requirement database 140.

A specific example of a calculation process according to method 200 is provided below in Table 1. The interval is 30 minutes, and each contact type can be handled by each skill group.

TABLE 1
EXAMPLE CALCULATION

| | | | | | Single-Skill | | |
|---|---|---|---|---|---|---|---|
| | | | | | Multi- | | |
| | | Processing | | | Session | | |
| Contact | Contact | Time | Service | Workload | Staff | | MSOC |
| Type | Volume | (Seconds) | Objective | (FTE) | Requirement | Capacity | Requirement |
| CHAT | 200 | 600 | 90% in 30 | 66.67 | 72.00 | 5.33 | |
| | | | seconds | | | | |
| VOICE | 150 | 350 | 80% in 20 | 29.17 | 35.00 | 5.83 | |
| | | | seconds | | | | |

Chat-normalized Voice Volume (using Chat Processing Time and Chat Service Objective and Voice Capacity)

| | | | | | |
|---|---|---|---|---|---|
| 220 | 600 | 90% in 30 | 73.33 | 79.16 | 5.83 |
| | | seconds | | | |

Combined Chat Volume and Chat-normalized Voice Volume

| | | | | | |
|---|---|---|---|---|---|
| 420 | 600 | 90% in 30 | 140.00 | 149.00 | 9.00 |
| | | seconds | | | |

Chat MSOC Requirement

| | |
|---|---|
| =(149.00 * 200)/(200 + 220) | 70.95 |

Table 1 demonstrates how the MSOC requirement estimation was performed on chats, which can be served simultaneously (e.g., multi-session). As shown above, there were two contact types, chat and voice. Based on single-skill multi-session simulation, the single-skill multi-session staff requirement for voice is 35.0 with the potential capacity of 5.83 to help other contact types. The volume for chat that has the capacity of 5.83 is 220, based on cached simulation results (e.g., solving the equation f₄(vⱼ⁴, p₄, s₄)−E(vⱼ⁴p₄)=c). This is the chat normalized voice volume. The combined volume of chat and chat normalized volumes is 420 (220+200). This combined volume corresponds to 149 FTE as the single-skill multi-session staff requirement, which is prorated to chat, resulting in an MSOC staff requirement for chat that is 70.95.

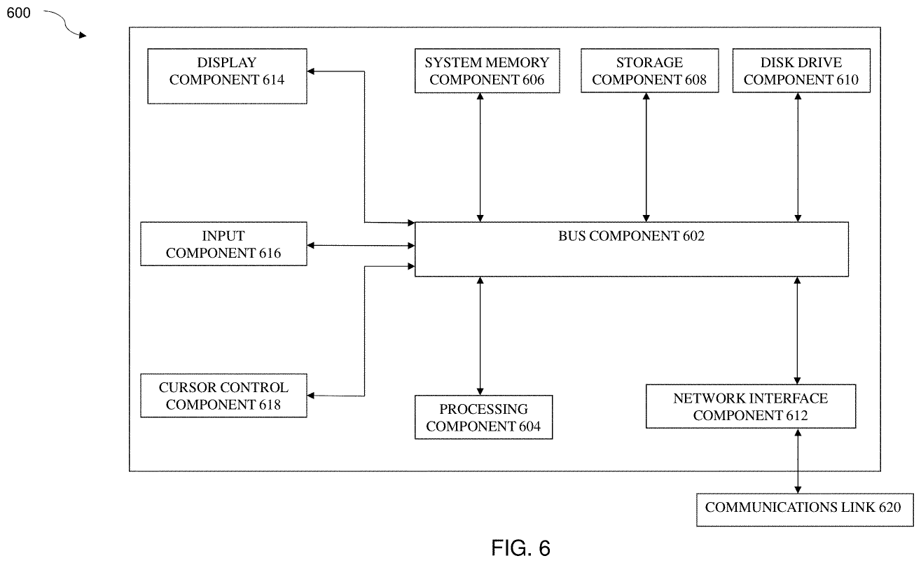

Referring now to FIG. 6, illustrated is a block diagram of a system 600 suitable for implementing embodiments of the present disclosure. System 600, such as part a computer and/or a network server, includes a bus 602 or other communication mechanism for communicating information, which interconnects subsystems and components, including one or more of a processing component 604 (e.g., processor, micro-controller, digital signal processor (DSP), etc.), a system memory component 606 (e.g., RAM), a static storage component 608 (e.g., ROM), a network interface component 612, a display component 614 (or alternatively, an interface to an external display), an input component 616 (e.g., keypad or keyboard), and a cursor control component 618 (e.g., a mouse pad).

In accordance with embodiments of the present disclosure, system 600 performs specific operations by processor 604 executing one or more sequences of one or more instructions contained in system memory component 606. Such instructions may be read into system memory component 606 from another computer readable medium, such as static storage component 608. These may include instructions to receive a plurality of contact volumes, a plurality of processing times, and a plurality of service objectives for each of a plurality of contact types; calculate workload staff requirement values for a range of the plurality of contact volumes, a range of the plurality of processing times, and a range of the plurality of service objectives for each of the plurality of contact types; store the workload staff requirement values; receive a number of simultaneous sessions allowed for each of the plurality of contact types; calculate single-skill multi-session staff requirement estimates for the range of the plurality of contact volumes, the range of the plurality of processing times, and the range of the plurality of service objectives for each of the plurality of contact types based on the number of simultaneous sessions allowed; store the single-skill multi-session staff requirement estimates; receive a plurality of skill groups and a plurality of contact types each skill group may serve; map the plurality of contact types to the plurality of skill groups; define relationships among the plurality of contact types based on the mapping of the plurality of contact types to the plurality of skill groups; select a contact type from the plurality of contact types; retrieve, from the stored workload staff requirement values and the stored single-skill multi-session staff requirement estimates, a staff requirement estimate corresponding to a defined contact volume, a defined processing time, and a defined service objective for each contact type; determine a capacity for agents serving the selected contact type to also serve other contact types from the plurality of contact types; determine a plurality of normalized contact volumes for each contact type that is related to the selected contact type using the determined capacity of the agents, by normalizing each contact volume to the selected contact type based on the defined processing time and the defined service objective of the selected contact type; determine a staff requirement estimate for the selected contact type based on the defined contact volume of the selected contact type, the normalized contact volume of each contact type that is related to the selected contact type, and the mapping of the plurality of contact types to the plurality of skill groups; and store the staffing requirement estimate for the selected contact type in a database.

In other embodiments, hard-wired circuitry may be used in place of or in combination with software instructions for implementation of one or more embodiments of the disclosure.

Logic may be encoded in a computer readable medium, which may refer to any medium that participates in providing instructions to processor 604 for execution. Such a medium may take many forms, including but not limited to, non-volatile media, volatile media, and transmission media. In various implementations, volatile media includes dynamic memory, such as system memory component 606, and transmission media includes coaxial cables, copper wire, and fiber optics, including wires that comprise bus 602. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 600. In various other embodiments, a plurality of systems 600 coupled by communication link 620 (e.g., LAN, WLAN, PTSN, or various other wired or wireless networks) may perform instruction sequences to practice the disclosure in coordination with one another. Computer system 600 may transmit and receive messages, data, information and instructions, including one or more programs (i.e., application code) through communication link 620 and communication interface 612. Received program code may be executed by processor 604 as received and/or stored in disk drive component 610 or some other non-volatile storage component for execution.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A staff requirement calculation system comprising:
a processor and a computer readable medium operably coupled thereto, the computer readable medium comprising a plurality of instructions stored in association therewith that are accessible to, and executable by, the processor, to perform operations which comprise:
receiving a plurality of contact volumes, a plurality of processing times, and a plurality of service objectives for each of a plurality of contact types;
calculating workload staff requirement values for a range of the plurality of contact volumes, a range of the plurality of processing times, and a range of the plurality of service objectives for each of the plurality of contact types;
storing the workload staff requirement values;
receiving a number of simultaneous sessions allowed for each of the plurality of contact types;
calculating single-skill multi-session staff requirement estimates for the range of the plurality of contact volumes, the range of the plurality of processing times, and the range of the plurality of service objectives for each of the plurality of contact types based on the number of simultaneous sessions allowed;
storing the single-skill multi-session staff requirement estimates;
receiving a plurality of skill groups and a plurality of contact types each skill group may serve;
mapping the plurality of contact types to the plurality of skill groups;
defining relationships among the plurality of contact types based on the mapping of the plurality of contact types to the plurality of skill groups;
selecting a contact type from the plurality of contact types;
retrieving, from the stored workload staff requirement values and the stored single-skill multi-session staff requirement estimates, a staff requirement estimate corresponding to a defined contact volume, a defined processing time, and a defined service objective for each contact type;
determining a capacity for agents serving the selected contact type to also serve other contact types from the plurality of contact types;
determining a plurality of normalized contact volumes for each contact type that is related to the selected contact type using the determined capacity for the agents, by normalizing each contact volume to the selected contact type based on the defined processing time and the defined service objective of the selected contact type;
determining a staff requirement estimate for the selected contact type based on the defined contact volume of the selected contact type, the normalized contact volume of each contact type that is related to the selected contact type, and the mapping of the plurality of contact types to the plurality of skill groups; and
storing the staffing requirement estimate for the selected contact type in a database.

2. The staff requirement calculation system of claim 1, wherein the operations further comprise receiving a change to one of the plurality of contact volumes, a change to one of the plurality of processing times, or a change to one of the plurality of service objectives.

3. The staff requirement calculation system of claim 2, wherein the operations further comprise generating an updated staff requirement estimate for the selected contact type based on the change.

4. The staff requirement calculation system of claim 1, wherein calculating single-skill multi-session staff requirement estimates comprises using an Erlang algorithm or a single-skill multi-session simulation.

5. The staff requirement calculation system of claim 1, wherein determining the plurality of normalized contact volumes comprises using an Erlang algorithm or a single-skill multi-session simulation.

6. The staff requirement calculator system of claim 1, wherein the operations further comprise displaying to a user the plurality of contact volumes, the plurality of processing times, the plurality of service objectives, and the staff requirement estimate for the selected contact type.

7. The staff requirement calculation system of claim 1, wherein the plurality of contact types comprise phone, live chat, messaging chat, short message service (SMS), email, social media, or any combination thereof.

8. A method of determining a staff requirement, which comprises:
receiving a plurality of contact volumes, a plurality of processing times, and a plurality of service objectives for each of a plurality of contact types;
calculating workload staff requirement values for a range of the plurality of contact volumes, a range of the plurality of processing times, and a range of the plurality of service objectives for each of the plurality of contact types;
storing the workload staff requirement values;
receiving a number of simultaneous sessions allowed for each of the plurality of contact types;
calculating single-skill multi-session staff requirement estimates for the range of the plurality of contact volumes, the range of the plurality of processing times, and the range of the plurality of service objectives for each of the plurality of contact types based on the number of simultaneous sessions allowed;
storing the single-skill multi-session staff requirement estimates;
receiving a plurality of skill groups and a plurality of contact types each skill group may serve;
mapping the plurality of contact types to the plurality of skill groups;
defining relationships among the plurality of contact types based on the mapping of the plurality of contact types to the plurality of skill groups;
selecting a contact type from the plurality of contact types;
retrieving, from the stored workload staff requirement values and the stored single-skill multi-session staff requirement estimates, a staff requirement estimate corresponding to a defined contact volume, a defined processing time, and a defined service objective for each contact type;
determining a capacity for agents serving the selected contact type to also serve other contact types from the plurality of contact types;
determining a plurality of normalized contact volumes for each contact type that is related to the selected contact type using the determined capacity of the agents, by normalizing each contact volume to the selected contact type based on the defined processing time and the defined service objective of the selected contact type;
determining a staff requirement estimate for the selected contact type based on the defined contact volume of the selected contact type, the normalized contact volume of each contact type that is related to the selected contact type, and the mapping of the plurality of contact types to the plurality of skill groups, and
storing the staffing requirement estimate for the selected contact type in a database.

9. The method of claim 8, further comprising receiving a change to one of the plurality of contact volumes, a change to one of the plurality of processing times, or a change to one of the plurality of service objectives.

10. The method of claim 9, further comprising generating an updated staff requirement estimate for the selected contact type based on the change.

11. The method of claim 8, wherein calculating single-skill multi-session staff requirement estimates comprises using an Erlang algorithm or a single-skill multi-session simulation.

12. The method of claim 8, wherein determining the plurality of normalized contact volumes comprises using an Erlang algorithm or a single-skill multi-session simulation.

13. The method of claim 8, wherein further comprising displaying to a user the plurality of contact volumes, the plurality of processing times, the plurality of service objectives, and the staff requirement estimate for the selected contact type.

14. The method of claim 8, wherein the plurality of contact types comprise phone, live chat, messaging chat, short message service (SMS), email, social media, or any combination thereof.

15. A non-transitory computer-readable medium having stored thereon computer-readable instructions executable by a processor to perform operations which comprise:
receiving a plurality of contact volumes, a plurality of processing times, and a plurality of service objectives for each of a plurality of contact types;
calculating workload staff requirement values for a range of the plurality of contact volumes, a range of the plurality of processing times, and a range of the plurality of service objectives for each of the plurality of contact types;
storing the workload staff requirement values;
receiving a number of simultaneous sessions allowed for each of the plurality of contact types;
calculating single-skill multi-session staff requirement estimates for the range of the plurality of contact volumes, the range of the plurality of processing times, and the range of the plurality of service objectives for each of the plurality of contact types based on the number of simultaneous sessions allowed;
storing the single-skill multi-session staff requirement estimates;
receiving a plurality of skill groups and a plurality of contact types each skill group may serve;
mapping the plurality of contact types to the plurality of skill groups;
defining relationships among the plurality of contact types based on the mapping of the plurality of contact types to the plurality of skill groups;
selecting a contact type from the plurality of contact types;
retrieving, from the stored workload staff requirement values and the stored single-skill multi-session staff requirement estimates, a staff requirement estimate corresponding to a defined contact volume, a defined processing time, and a defined service objective for each contact type;
determining a capacity for agents serving the selected contact type to also serve other contact types from the plurality of contact types;
determining a plurality of normalized contact volumes for each contact type that is related to the selected contact type using the determined capacity of the agents, by normalizing each contact volume to the selected contact type based on the defined processing time and the defined service objective of the selected contact type;
determining a staff requirement estimate for the selected contact type based on the defined contact volume of the selected contact type, the normalized contact volume of each contact type that is related to the selected contact type, and the mapping of the plurality of contact types to the plurality of skill groups; and
storing the staffing requirement estimate for the selected contact type in a database.

16. The non-transitory computer-readable medium of claim 15, wherein the operations further comprise receiving a change to one of the plurality of contact volumes, a change to one of the plurality of processing times, or a change to one of the plurality of service objectives.

17. The non-transitory computer-readable medium of claim 16, wherein the operations further comprise generating an updated staff requirement estimate for the selected contact type based on the change.

18. The non-transitory computer-readable medium of claim 15, wherein calculating single-skill multi-session staff requirement estimates comprises using an Erlang algorithm or a single-skill multi-session simulation.

19. The non-transitory computer-readable medium of claim 15, wherein determining the plurality of normalized contact volumes comprises using an Erlang algorithm or a single-skill multi-session simulation.

20. The non-transitory computer-readable medium of claim 15, wherein the operations further comprise displaying to a user the plurality of contact volumes, the plurality of processing times, the plurality of service objectives, and the staff requirement estimate for the selected contact type.
